(19) United States
(12) Patent Application Publication
(10) Pub. No.: US 2008/0076087 A1
(43) Pub. Date: Mar. 27, 2008

(54) Optical component anti-fogging system, oral cavity internal observation device, and anti-fogging method

(75) Inventors: Takuji Horie, Sagamihara-shi (JP); Hiroyoshi Kobayashi, Tokyo (JP); Akira Matsushita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/901,857

(22) Filed: Sep. 19, 2007

(30) Foreign Application Priority Data
Sep. 26, 2006 (JP) 2006-260390

(51) Int. Cl. G02B 1/00; A61C 1/00

(52) U.S. Cl. 433/29; 359/512

(57) ABSTRACT

A sufficient anti-fogging effect for an optical component is realized, regardless of variation in resistance value of a transparent conductive film over time. There is provided an anti-fogging system for an optical component, comprising a transparent conductive film covering a surface of an optical component that reflects or transmits light, a resistance value detection section for detecting a resistance value of the transparent conductive film, a characteristic storage section for storing an electrical temperature characteristic of the transparent conductive film, a control section for controlling power supplied to the transparent conductive film based on the electrical temperature characteristic stored in the characteristic storage section and resistance value of the transparent conductive film detected by the resistance value detection section, and a temperature characteristic update section for updating the temperature characteristic of the transparent conductive film stored in the characteristic storage section.

### BACKGROUND OF THE INVENTION

1. Field of the Invention

The present invention relates to an optical element anti-fogging system, an oral cavity internal observation device, and an anti-fogging method.

This application is based on Japanese Patent Application No. 2006-260390, the content of which is incorporated herein by reference.

2. Description of Related Art

Conventionally, as anti-fogging technology for windshields there has been disclosed technology in which a transparent conductive film is bonded to the windshield and the transparent conductive film is heated so that the temperature of the windshield becomes a predetermined temperature or more higher than the dew-point temperature, and at that time the transparent conductive film is used in measurement of the temperature of the windshield (refer to Japanese Unexamined Patent Application, Publication No. 2004-191249, for example.

According to this patent publication 1, measurement of the temperature of the windshield is measured by measuring a resistance value of the transparent conductive film, utilizing the fact that the resistance value of the transparent conductive film varies according to temperature variation.

However, the resistance value of transparent conductive film varies with time due to the effects of components in the air, separately from the resistance value variation due to temperature variation described above. Therefore, if used over a long period of time, temperature measured using the transparent conductive film resistance value measurement will be different from the actual temperature. Therefore, there are problems of not sufficiently heating the windshield so that it is not possible to exhibit the anti-fogging effect.

### BRIEF SUMMARY OF THE INVENTION

The present invention has been conceived in view of the above-described situation, and an object of the invention is to provide an optical component anti-fogging system, an oral cavity internal observation device, and an anti-fogging method that can realize a sufficient anti-fogging effect for an optical component regardless of variation in resistance value of a transparent conductive film over time.

In order to achieve the above-described object, the invention provides the following means.

One aspect of the present invention provides an anti-fogging system for an optical component, comprising a transparent conductive film covering a surface of an optical component that reflects or transmits light, a resistance value detection section for detecting a resistance value of the transparent conductive film, a characteristic storage section for storing an electrical temperature characteristic of the transparent conductive film, a control section for controlling power supplied to the transparent conductive film based on the electrical temperature characteristics stored in the characteristic storage section and resistance value of the transparent conductive film detected by the resistance value detection section, and a temperature characteristic update section for updating the temperature characteristic of the transparent conductive film stored in the characteristic storage section.

According to the first aspect of the present invention, if power (for example, voltage or current) is supplied to the transparent conductive film by the operation of the control section, the surface of the optical component covered by the transparent conductive film is heated. If the surface temperature of the optical component is maintained higher than the dew-point temperature by a predetermined temperature, it is possible to prevent the surface of the optical component misting over. Since the resistance value of the transparent conductive film varies with temperature, it is possible to confirm the temperature of the transparent conductive film based on the resistance value of the transparent conductive film detected by the resistance value detecting section.

Accordingly, if the control section sets a temperature that prevents misting over of the optical component, a target resistance value capable of preventing misting over of the optical component is obtained based on an electrical temperature characteristic (for example, resistance value) of the transparent conductive film stored in the characteristic storage section. It is therefore possible to prevent misting over of the optical component by controlling voltage so that a resistance value of the transparent conductive film detected by the resistance value detecting section becomes the target resistance value.

In this case, according to the first aspect of the present invention, the electrical temperature characteristic of the transparent conductive film stored in the characteristic storage section is updated by operation of the temperature characteristic update section. In this way, voltage supplied to the transparent conductive film is controlled so that even if the resistance value of the transparent conductive film varies over time, it will become a resistance value for reaching a temperature required to prevent misting. As a result, it becomes possible to prevent the optical component misting over regardless of variation in the resistance value of the transparent conductive film over time.

In the above-described first embodiment of the present invention, it is possible for the characteristic storage section to store a resistance value of the transparent conductive film, a temperature of the transparent conductive film when the resistance value is measured, and a resistance temperature coefficient of the transparent conductive film for temperature variation, and for the temperature characteristic update section to be provided with a temperature sensor for detecting temperature of the transparent conductive film, and updating the temperature and resistance value of the transparent conductive film stored in the characteristic storage section to the temperature of the transparent conductive film detected by the temperature sensor and the resistance value of the transparent conductive film at that point in time, when the transparent conductive film is in a thermal equilibrium state.

By doing this, the temperature characteristic of the transparent conductive film is updated by causing operation of the temperature characteristic update section either periodically or as required.

In this case, resistance value and temperature of the transparent conductive film when the transparent conductive film is in a thermal equilibrium state are adopted as the resistance value and temperature stored in the characteristic storage section. Therefore, as a temperature sensor it is sufficient to be able to detect temperature at one place of the transparent conductive film, or close to one place of the transparent conductive film, and not detect the temperature of the whole of the transparent conductive film. Accordingly, it becomes possible to adopt a temperature sensor that has little variation over time, and it is possible to update the temperature characteristic of the transparent conductive film easily and with better precision.

Also, in the first aspect of the present invention, it is possible to provide a thermal equilibrium state determination section for determining a thermal equilibrium state of the transparent conductive film, and to store the temperature of the transparent conductive film detected by the temperature sensor and the resistance value of the transparent conductive film detected by the resistance value detection section in the characteristic storage section when it is determined by the thermal equilibrium state determination section that the transparent conductive film is in a thermal equilibrium state.

In this way, a thermal equilibrium state is determined by operation of the thermal equilibrium state determining section, and the temperature characteristic of the temperature characteristic storage section is updated automatically. Accordingly, it is possible to calibrate the temperature characteristic in the thermal equilibrium state where a device containing the optical component is not used etc., and it is possible to adjust the temperature at the time of use accurately and prevent misting up of the optical component.

Also, with the above-described first aspect of the present invention, the thermal equilibrium state determination section can determine that the transparent conductive film is in a thermal equilibrium state when the temperature of the transparent conductive film detected by the temperature sensor becomes an equilibrium state.

Also, with the above described first aspect of the present invention, the thermal equilibrium state determination section can determine that the transparent conductive film is in a thermal equilibrium state when the resistance value of the transparent conductive film detected by the resistance value detection section becomes an equilibrium state.

Also, with the above described first aspect of the present invention, the thermal equilibrium state determination section can determine that the transparent conductive film is in a thermal equilibrium state after a predetermined time has elapsed from cessation of supply of voltage to the transparent conductive film.

Also, in the above described first aspect of the present invention, it is possible for the control section to control a voltage applied to the transparent conductive film at the time of detecting resistance value of the transparent conductive film by the resistance value detecting section, during heating of the optical component by supplying voltage to the transparent conductive film, to be lower than a voltage applied to the transparent conductive film when heating the transparent film.

By doing this, it is possible to control heating of the transparent conductive film during detection of the resistance value, and to make heating control simple.

Also, in the above described first aspect of the present invention, it is possible for the control section to obtain a difference between a target temperature for heating the transparent conductive film and a temperature of the transparent conductive film stored in the characteristic storage section, obtain a resistance value variation amount by multiplying the obtained difference by a resistance temperature coefficient stored in the characteristic storage section, and obtain a target resistance value for the transparent conductive film by adding the resistance value of the transparent conductive film stored in the characteristic storage section to the obtained resistance value variation amount.

By doing this, it is possible to easily calculate a target resistance vale for the transparent conductive film in order to achieve the target temperature for heating the transparent conductive film. More specifically, since there is no variation over time in the resistance temperature coefficient of the transparent conductive film, it is possible to calculate the resistance value of the transparent conductive film that will be the target more accurately, by updating the temperature and resistance value of the transparent conductive film being stored in the characteristic storage section by the temperature characteristic update section.

Also, in the present invention described above, it is possible for the transparent conductive film to be a compound containing indium oxide and tin oxide, tin oxide, titanium oxide or zinc oxide.

By doing this, it is possible for the transparent conductive film to exhibit a desirable resistance value variation for temperature variation, even if the transparent conductive film is formed on glass, and to prevent misting up of the optical component by accurately adjusting temperature.

Also, a second aspect of the present invention provides an oral cavity inspection device, comprising an optical component, facing into an oral cavity, that reflects or transmits light, a transparent conductive film covering a surface of the optical component, a resistance value detection section for detecting a resistance value of the transparent conductive films, a characteristic storage section for storing an electrical temperature characteristic of the transparent conductive film, a control section for controlling power supplied to the transparent conductive film based on the electrical temperature characteristic of the transparent conductive film stored in the characteristic storage section and resistance value of the transparent conductive film detected by the resistance value detection section, and a temperature characteristic update section for updating the temperature characteristic of the transparent conductive film stored in the characteristic storage section.

Also, a third aspect of the present invention provides an anti-fogging method for an optical component, a resistance value detection step for detecting a resistance value of a transparent conductive film covering a surface of an optical component that reflects or transmits light, a characteristic storage step for storing an electrical temperature characteristic of the transparent conductive film, a control step for controlling power supplied to the transparent conductive film based on the electrical temperature characteristic stored in the characteristic storage step and resistance value of the transparent conductive film detected in the resistance value detection step, and a temperature characteristic update step for updating the temperature characteristic of the transparent conductive film stored in the characteristic storage step.

Here, it is possible, in the characteristic storage step, to store a resistance value of the transparent conductive film, a temperature of the transparent conductive film when the resistance value is measured, and a resistance temperature coefficient of the transparent conductive film for temperature variation, and, in the temperature characteristic update step, to update the temperature and resistance value of the transparent conductive film stored in the characteristic storage step to the temperature of the transparent conductive film when the transparent conductive film is in a thermal equilibrium state, and the resistance value of the transparent conductive film at that point in time.

In the above described third aspect of the present invention, it is possible to provide a thermal equilibrium state determination step, before the characteristic storage step, for determining a thermal equilibrium state of the transparent conductive film, and in the characteristic storage step to store the temperature of the transparent conductive film when it is determined in the thermal equilibrium state determination step that the transparent conductive film is in a thermal equilibrium state, and the resistance value of the transparent conductive film at that point in time.

It is also possible, in the control step, to control a voltage applied to the transparent conductive film at the time of detecting resistance value of the transparent conductive film in the resistance value detecting step, during heating of the optical component by supplying voltage to the transparent conductive film, to be lower than a voltage applied to the transparent conductive film when heating the transparent film.

It is possible, in the control step, to obtain a difference between a target temperature for heating the transparent conductive film and a temperature of the transparent conductive film stored in the characteristic storage step, obtain a resistance value variation amount by multiplying the obtained difference by a resistance temperature coefficient stored in the characteristic storage step, and obtain a target resistance value for the transparent conductive film by adding the resistance value of the transparent conductive film stored in the characteristic storage step to the obtained resistance value variation amount.

According to the present invention, the effect is achieved of being able to realize a sufficient anti-fogging effect for an optical component, regardless of variation in resistance value of a transparent conductive film over time.

### BRIEF DESCRIPTION OF THE SEVERAL VIEWS OF THE DRAWINGS

FIG. 1 is a block diagram showing the overall structure of an anti-fogging system for an optical component relating to a first embodiment of the present invention.

FIG. 2 is a block diagram showing a characteristic calibration section for the anti-fogging system of FIG. 1.

FIG. 3 is a drawing showing a voltage control timing chart for the anti-fogging system of FIG. 1.

FIG. 4 is a flow chart for describing a temperature control method used in the anti-fogging system of FIG. 1.

FIG. 5 is a flow chart for describing a temperature characteristic update method used in the anti-fogging system of FIG. 1.

FIG. 6 is a graph for describing a thermal equilibrium state of the anti-fogging system of FIG. 1.

### DETAILED DESCRIPTION OF THE INVENTION

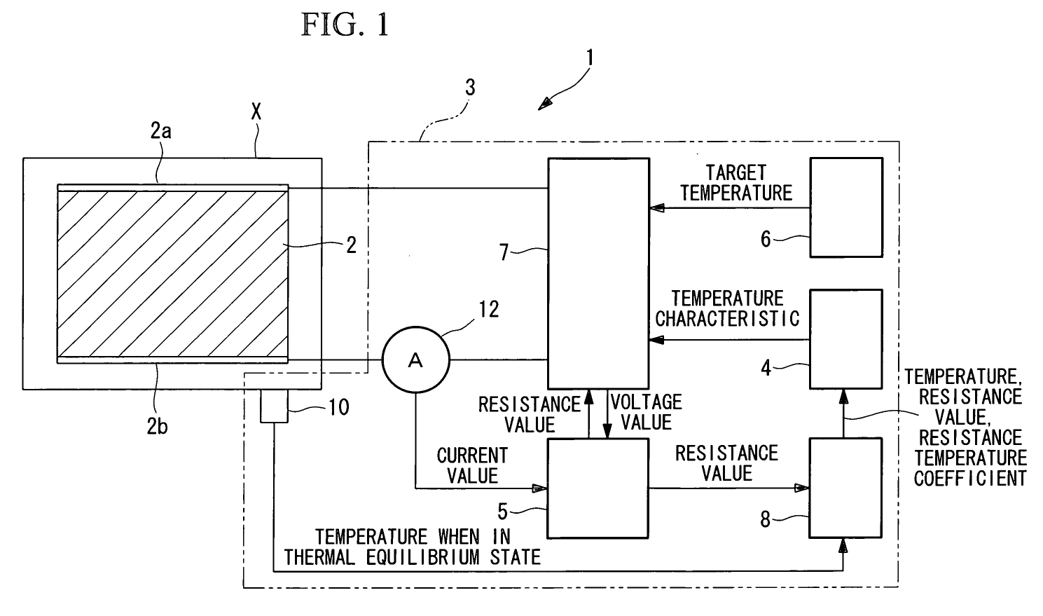

An anti-fogging system 1 for an optical component X of the first embodiment will be described in the following with reference to FIG. 1 to FIG. 5.

The anti-fogging system 1 for an optical component X of this embodiment is an anti-fogging system 1 for an optical component X that reflects or transmits light, such as, for example, a tip lens or cover glass directed into an oral cavity of an oral cavity internal observation device. As shown in FIG. 1, this anti-fogging system 1 comprises a transparent conductive film 2 provided so as to cover the surface of an optical component X, and a temperature control unit 3 for controlling temperature of the transparent conductive film 2.

The transparent conductive film 2 is formed on the surface of the optical component X, for example. The transparent conductive film 2 has a predetermined electrical temperature characteristic (for example, at an early stage, at a temperature of 20° C., a resistance value of 70Ω, and a resistance temperature coefficient of 600 ppm/° C.). Here, resistance temperature coefficient means a rate of variation in resistance value for temperature variation. Electrodes 2a and 2b are provided on the transparent conductive film 2, and the transparent conductive film 2 is heated by current flowing due to application of a voltage across the electrodes 2a and 2b.

Also, the transparent conductive electrode 2 has a resistance value that varies in accordance with temperature variation. For example, in the case of a temperature variation from 20° C. to 21° C., the resistance value is increased by a resistance value variation amount of 70Ω600×10⁻⁶=0.042Ω/° C., and when temperature is 21 C resistance value becomes 70.042Ω. Here, the resistance temperature coefficient of the transparent conductive film 2 (for example 600 ppm/° C.) does not vary over time, and a resistance value can always be calculated using the same value. On the other hand, the resistance value with respect to temperature of the transparent conductive film 2 does vary over time. It is therefore necessary to carry out calibration, which will be described later.

It is preferable to use a material that exhibits a good resistance value variation for temperature variation as the transparent conductive film 2. Specifically, such materials may include a compound containing indium oxide and tin oxide, tin oxide, titanium oxide or zinc oxide.

As shown in FIG. 1, the temperature control unit 3 comprises a characteristic storage section 4 for storing electrical temperature characteristics (the temperature, resistance value, and resistance temperature coefficient) of the transparent conductive film 2, a resistance value detection section 5 for detecting the resistance value of the transparent conductive film 2, a target temperature setting section 6 for setting the target temperature of the transparent conductive film 2, and a voltage control section 7 for controlling a voltage supplied to the transparent conductive film 2 such that the resistance value of the transparent conductive film 2 detected by the resistance value detection section 5 becomes a target resistance value corresponding to the target temperature.

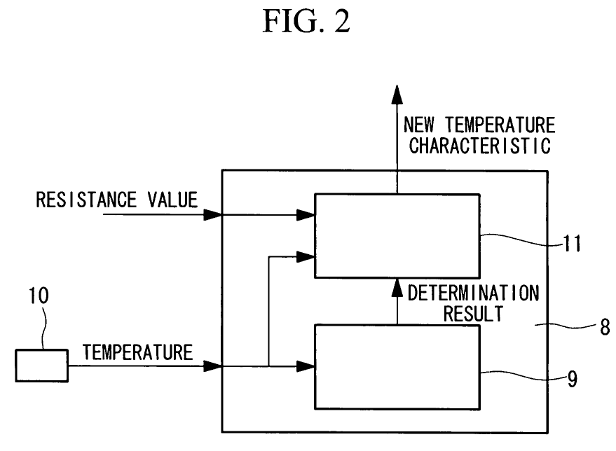

Also, a characteristic calibration section 8 for calibrating the temperature characteristics stored in the characteristic storage section 4 as required or periodically, is provided in the temperature control section 3. As shown in FIG. 2, the characteristic calibration section 8 comprises a thermal equilibrium state determination section 9 for determining whether or not at least the transparent conductive film 2 is in a thermal equilibrium state, a temperature sensor 10 for detecting temperature of the transparent conductive film 2, and a characteristic update section 11 for rewriting the temperature and resistance value in the characteristic storage section 4, with the temperature of the transparent conductive film 2 detected by the temperature sensor 10 and the resistance value of the transparent conductive film 2 at the time the temperature is detected as a new temperature and resistance value, when it is determined by the thermal equilibrium state determination section 9 that the transparent conductive film 2 is in a state of thermal equilibrium.

The thermal equilibrium state determination section 9 determines a state of thermal equilibrium from the temperature detected by the temperature sensor 10 becoming a static state.

Operation of an anti-fogging system 1 for an optical component X of this embodiment constructed as described above will be described in the following.

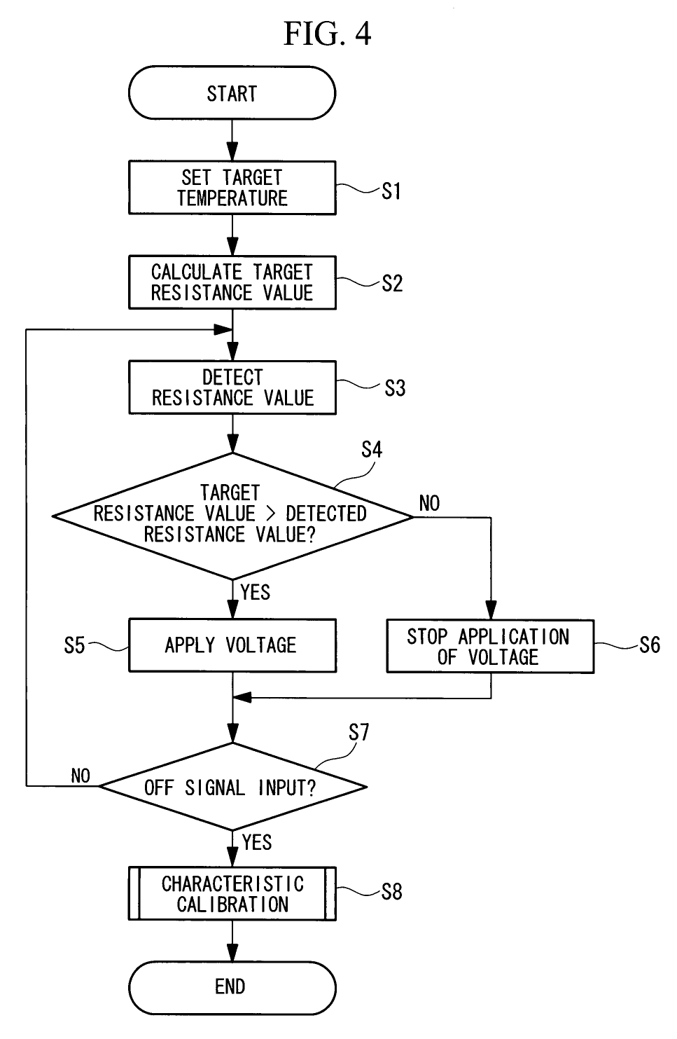

In attempting to prevent misting up of the surface of an optical component X using the anti-fogging system 1 of this embodiment, as shown in FIG. 4, first a target temperature to which the surface of the optical component X is to be heated (specifically a target temperature of the transparent conductive film 2) is set by the target temperature setting section 6 (Step 1). Setting of the target temperature can be done using a value stored in advance in the target temperature setting section 6, or can be input to the target temperature setting section 6 using arbitrary input means (not shown).

The set target temperature is sent to the voltage control section 7, and the target temperature is converted to a target resistance value using operation of the voltage control section 7 (Step 2). Conversion of the target temperature to target resistance value first involves calculating a difference between the target temperature set in the target temperature setting section 6 and the temperature stored in the characteristic storage section 4. This difference is then multiplied by the resistance value temperature coefficient per 1° C. temperature variation similarly stored in the characteristic storage section 4. Further, conversion to a target resistance value for the target temperature is carried out by adding the stored resistance value to the resistance value variation amount obtained through multiplication.

Next, the resistance value of the transparent conductive film 2 is detected by operation of the resistance value detection section 5 in the temperature control unit 3 (Step 3). Detection of the resistance value can be carried out by applying a predetermined voltage to the transparent conductive film 2 by means of the voltage control section 7, and detecting current flowing. In the drawing, reference numeral 12 is a current detection section for detecting current flowing in the transparent conductive film 2. Alternatively, it is possible to apply a predetermined current to the transparent conductive film 2 and detect the voltage across the two ends of the transparent conductive film 2 using a voltage detection section (not shown).

If the resistance value of the transparent conductive film 2 is detected, the converted target resistance value and the detected resistance value are compared (step S4). In the event that the result of comparison is that the target resistance value is larger than the current resistance value, the voltage control section 7, supplies a predetermined voltage to the transparent conductive film 2, and heats the transparent conductive film 2 (step S5).

Also, in the event that the result of comparison described above is that the target resistance value is smaller than the current resistance value, the voltage control section 7 stops supply of the predetermined voltage to the transparent conductive film 2 (step S6), and stops the heating of the transparent conductive film 2. By repeating this, the voltage control section 7 controls the voltage applied to the transparent conductive film 2 so that the resistance value of the transparent conductive film 2 approaches the target resistance value, and it is possible to achieve the target temperature.

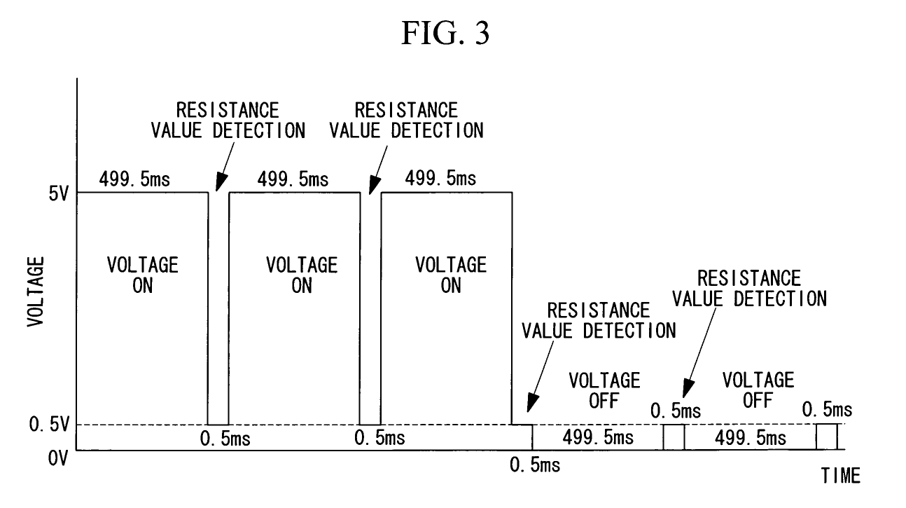

In this way, the voltage control section 7 controls the transparent conductive film 2 to the target temperature by supplying or not supplying the predetermined voltage. On the other hand, the voltage control section 7, carries out detection of the resistance value during temperature control for the transparent conductive film 2 at a predetermined cycle, as shown in FIG. 3, so as to detect average temperature of the surface of the optical component X, and feedback the detected value to the voltage control of the transparent conductive film 2. For example, when voltage control is carried out at a cycle of 500 msec, 499.5 msec corresponds to temperature control while the remaining 0.5 msec corresponds to resistance value detection.

Also, in this embodiment, the voltage control section 7 sets the voltage to be supplied to the transparent conductive film 2 at the time of temperature control to 5V, for example, and sets the voltage supplied at the time of resistance value detection to 0.5 V, for example. In this way, it is possible to control heating of the transparent conductive film 2 at the time of resistance value detection, and to make heating control simple. Also, since the voltage is made 0.5 V at the time of resistance value detection, and the duty ratio of the resistance value detection time is 1:1000, it is possible to reduce power consumption.

The transparent conductive film 2 is arranged so as to cover the entire surface of the optical component X. It is therefore possible to detect average temperature of the entire surface of the optical component X by detecting resistance value of the transparent conductive film 2. It is then possible to keep the optical component X from misting up by setting a temperature a few degrees higher than the dew-point temperature as the target temperature. It is then determined whether or not an off signal has been input to a power supply (not shown) for components provided in the anti-fogging system 1 (step S7), and if the off signal has not been input processing returns to step S3 where repeated temperature control is carried out.

Also, in the anti-fogging system 1 of this embodiment, the temperature characteristic of the transparent conductive film 2 stored in the characteristic storage section 4 is calibrated by operating the characteristic calibration section 8 as required or periodically.

As shown in FIG. 4, the characteristic calibration section 8 is activated when an off signal is input to the power supply for the components provided in the anti-fogging system 1 (step S8).

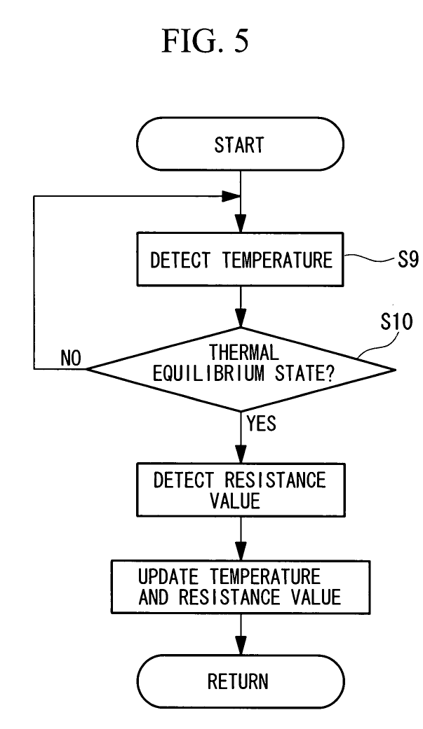

If the characteristic calibration section 8 is activated, then as shown in FIG. 5, the temperature sensor 10 is activated and temperature detection for the whole of the anti-fogging system 1, i.e. the transparent conductive film 2 and the optical component X etc., is commenced (step S9). Temperature detection by the temperature sensor 10 is carried out continuously or at a predetermined sample period. The thermal equilibrium state determination section 9 is then operated based on the detected temperature, to determine whether or not the transparent conductive film 2 is in a state of thermal equilibrium (step S10).

When it has been determined by the thermal equilibrium determination section 9 that the transparent conductive film 2 is not in a state of thermal equilibrium, temperature detection by the temperature sensor S10 (step S9) and determination (step S10) are repeated. On the other hand, when it is determined by the thermal equilibrium state determination section 9 that the transparent conductive film 2 is in a state of thermal equilibrium, the characteristic calibration section 8 is activated and the resistance value of the transparent conductive film 2 is detected by the resistance value detection section 5. The characteristic calibration section 8 updates the temperature characteristics in the characteristic storage section 4 by updating the resistance value detected by the resistance value detection section 5, and the temperature detected by the temperature sensor 10 at the point in time when a thermal equilibrium state is determined, as new temperature characteristics.

It is also possible to automatically switch the component power supply off after determining that the transparent conductive film 2 is in a state of thermal equilibrium and updating the temperature characteristics in the characteristic storage section 4. It is also possible to turn the component power supply off when the off signal is input to the component power supply, and after that, carry out determination of thermal equilibrium state of the transparent conductive film 2 and update of the temperature characteristics of the transparent conductive film 2 in the characteristic storage section 4 using an internal battery (not shown).

In this way, the next time power is input for the components included in the anti-fogging system 1 of this embodiment, the anti-fogging effect will be reliably exhibited based on the latest temperature characteristic for the transparent conductive film 2.

In this way, according to the anti-fogging system 1 of this embodiment, since the temperature characteristics of the transparent conductive film 2 are calibrated by operating the characteristic calibration section 8, it is possible to always store the latest accurately calibrated temperature characteristics even if the resistance value of the transparent conductive film 2 varies over time due to contact with components in the air. As a result, a target temperature is accurately achieved, and it can be expected to more reliably prevent misting up of the optical component X.

In this case, in the anti-fogging system 1 of this embodiment, periodic calibration of the temperature characteristics is carried out automatically with activation of the thermal equilibrium state determination section 9. Accordingly, it is possible to always prevent the optical component X misting up without the user carrying out a temperature characteristic calibration operation.

Also, when carrying out calibration of the temperature characteristics of the transparent conductive film 2, the temperature sensor 10 detects temperature in a state of thermal equilibrium. For this reason, as a temperature sensor 10 used for calibration, it is not necessary to detect average temperature over a wide range of the optical component X such as the transparent conductive film 2, and if suffices to measure the temperature at a single point of the optical component X or a single point close to the optical component X. It is therefore possible to adopt as the temperature sensor 10 a high accuracy temperature sensor 10 that does not vary over time like the transparent conductive film 2, and it is possible to carry out calibration of the temperature characteristic with good accuracy.

Also, in this embodiment, the transparent conductive film 2 is arranged so as to directly cover the whole of the optical component X. Therefore, it is possible to quickly and accurately control a target temperature for the optical component X compared to a case where a temperature measurement structure for the optical element X is provided separately and the temperature of the optical component X is controlled based on temperature measured by that temperature measurement structure.

Further, in the case of using a material such as a compound containing indium oxide and tin oxide, tin oxide, titanium oxide or zinc oxide as the material of the transparent conductive film 2, since the transparent conductive film 2 displays good resistance value variation with respect to temperature variation even when the transparent conductive film 2 is formed on glass, it is possible to adjust temperature with good accuracy. As a result, it is possible to reliably prevent misting up of the optical component X.

In this embodiment, using the voltage control section 7 of the temperature control unit 3, the voltage supplied to the transparent conductive film 2 is fixed at a predetermined voltage value, and temperature control is carried out by turning that voltage on and off. However, with the present invention it is also possible to adopt another control method instead. Also, when detecting resistance value of the transparent conductive film 2, a voltage that is sufficiently lower than the voltage supplied to the transparent conductive film 2 at the time of voltage control is supplied to the transparent conductive film 2 by the voltage control section 7. However, instead of this, it is also possible to supply the same voltage as the voltage supplied at the time of temperature control to the transparent conductive film 2.

Also, in this embodiment, a predetermined temperature, and the resistance value and resistance temperature coefficient at that time, are stored in the characteristic storage section 4. In this way, there is the advantage that fewer numerical values are required to be rewritten at the time of calibration of the temperature characteristic. Instead of this, it is also possible to store a coefficient or map relating to temperature and resistance value.

Also with this embodiment, a determination method for a state of thermal equilibrium is based on temperature detected by the temperature sensor 10. Instead of this, however, it is also possible to determine a thermal equilibrium state according to whether or not the resistance value of the transparent conductive film 2 detected by the resistance value detection section 5 is static.

As a method of determining the thermal equilibrium state, it is also possible to provide a timer (not shown), and determine a state of thermal equilibrium as a result of the timer clocking a predetermined time. For example, it is possible to determine the thermal equilibrium state after two minutes elapses from cessation of voltage supply to the transparent conductive film 2.

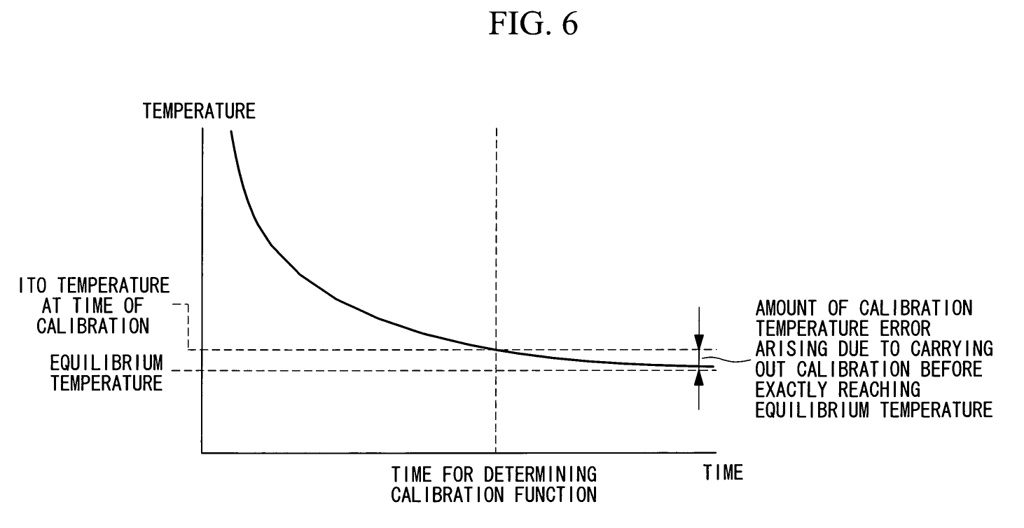

Also, in this embodiment, the thermal equilibrium state represents a state where equilibrium temperature is a temperature within about ±0.5° C. For example, as shown in FIG. 6, equilibrium temperature in a state of thermal equilibrium is predicted using a time variation rate for temperature detected by the temperature sensor 10. Then, when temperature is substantially within ±0.5° C. of the predicted equilibrium temperature it can be determined that there is a thermal equilibrium state. In this way it is possible to shorten the time required to calibrate the temperature characteristic. Also, a temperature that is a few degrees higher than a dew-point temperature is set as the above described target temperature. At this time, since the thermal equilibrium state is defined as described above, reported errors are reduced and it is possible to set the target temperature to be set at a lower value. It is therefore possible to reduce power consumed by the temperature control.

What is claimed is:

1. An anti-fogging system for an optical element, comprising:
a transparent conductive film for covering a surface of an optical element that reflects or transmits light;
a resistance value detection section for detecting a resistance value of the transparent conductive film;
a characteristic storage section for storing electrical temperature characteristics of the transparent conductive film;
a control section for controlling power supplied to the transparent conductive film, based on electrical temperature characteristics of the transparent conductive film stored in the characteristic storage section and resistance value of the transparent conductive film detected by the resistance value detection section; and
a temperature characteristic update section for updating temperature characteristics of the transparent conductive film stored in the characteristic storage section.

2. The anti-fogging system for an optical component of claim 1, wherein:
the characteristic storage section stores resistance value of the transparent conductive film, temperature of the transparent conductive film when the resistance value was measured, and a resistance temperature coefficient of the transparent conductive film for temperature variation; and
the temperature characteristic update section is provided with a temperature sensor for detecting temperature of the transparent conductive film, and updates the temperature and resistance value of the transparent conductive film stored in the characteristic storage section to the temperature of the transparent conductive film detected by the temperature sensor and the resistance value of the transparent conductive film at that point in time, when the transparent conductive film is in a thermal equilibrium state.

3. The anti-fogging system for an optical component of claim 2, provided with thermal equilibrium state determining section for determining that the transparent conductive film is in a state of thermal equilibrium, wherein:
the temperature of the transparent conductive film detected by the temperature sensor and the resistance value of the transparent conductive film detected by the resistance value detection section are stored in the characteristic storage section when it is determined by the thermal equilibrium state determination section that the transparent conductive film is in a thermal equilibrium state.

4. The anti-fogging system for an optical component of claim 3, wherein, the thermal equilibrium state determination section determines that the transparent conductive film is in a thermal equilibrium state when the temperature of the transparent conductive film detected by the temperature sensor becomes an equilibrium state.

5. The anti-fogging system for an optical component of claim 3, wherein the thermal equilibrium state determination section determines that the transparent conductive film is in a thermal equilibrium state when the resistance value of the transparent conductive film detected by the resistance value detection section becomes an equilibrium state.

6. The anti-fogging system for an optical component of claim 3, wherein the thermal equilibrium state determination section determines that the transparent conductive film is in a thermal equilibrium state after a predetermined time has elapsed from cessation of supply of voltage to the transparent conductive film.

7. The anti-fogging system for an optical component of claim 1, wherein the control section controls a voltage applied to the transparent conductive film at the time of detecting resistance value of the transparent conductive film by the resistance value detecting section, during heating of the optical component by supplying voltage to the transparent conductive film, to be lower than a voltage applied to the transparent conductive film when heating the transparent film.

8. The anti-fogging system for an optical component of claim 2, wherein the control section obtains a difference between a target temperature for heating the transparent conductive film and a temperature of the transparent conductive film stored in the characteristic storage section, obtains a resistance value variation amount by multiplying the obtained difference by a resistance temperature coefficient stored in the characteristic storage section, and obtains a target resistance value for the transparent conductive film by adding the resistance value of the transparent conductive film stored in the characteristic storage section to the obtained resistance value variation amount.

9. The anti-fogging system for an optical component of claim 1, wherein the transparent conductive film is a compound containing indium oxide and tin oxide, tin oxide, titanium oxide or zinc oxide.

10. An oral cavity inspection device, comprising:
an optical component, facing into an oral cavity, that reflects or transmits light;
a transparent conductive film covering a surface of the optical component;
a resistance value detection section for detecting a resistance value of the transparent conductive film;
a characteristic storage section for storing electrical temperature characteristics of the transparent conductive film;
a control section for controlling power supplied to the transparent conductive film, based on electrical temperature characteristics of the transparent conductive film stored in the characteristic storage section and resistance value of the transparent conductive film detected by the resistance value detection section; and
a temperature characteristic update section for updating temperature characteristics of the transparent conductive film stored in the characteristic storage section.

11. An anti-fogging method for an optical element, comprising:
a resistance value detecting step of detecting a resistance value of a transparent conductive film for covering a surface of an optical element that reflects or transmits light;
a characteristic storage step of storing electrical temperature characteristics of the transparent conductive film;
a control step of controlling power supplied to the transparent conductive film, based on electrical temperature characteristics of the transparent conductive film stored in the characteristic storage step and resistance value of the transparent conductive film detected in the resistance value detection step; and
a temperature characteristic update step of updating temperature characteristics of the transparent conductive film stored in the characteristic storage step.

12. The anti-fogging method for an optical component of claim 11, wherein:
in the characteristic storage step, resistance value of the transparent conductive film, temperature of the transparent conductive film when the resistance value was measured, and a resistance temperature coefficient of the transparent conductive film for temperature variation, are stored; and
in the temperature characteristic update step, the temperature and resistance value of the transparent conductive film stored in the characteristic storage step are updated to the temperature of the transparent conductive film when the transparent conductive film is in a thermal equilibrium state, and the resistance value of the transparent conductive film at that point in time.

13. The anti-fogging method for an optical component of claim 12, provided with a thermal equilibrium state determining step of determining that the transparent conductive film is in a state of thermal equilibrium, before the characteristic storage step, wherein:
in the characteristic storage step, the temperature of the transparent conductive film, when the transparent conductive film is determined to be in a thermal equilibrium state in the thermal equilibrium state determining step, and a resistance value of the transparent conductive film at that point in time, are stored.

14. The anti-fogging method for an optical component of claim 11, wherein in the control step a voltage applied to the transparent conductive film at the time of detecting resistance value of the transparent conductive film in the resistance value detecting step, during heating of the optical component by supplying voltage to the transparent conductive film, is controlled to be lower than a voltage applied to the transparent conductive film when heating the transparent film.

15. The anti-fogging method for an optical component of claim 12, wherein, in the control step, a difference between a target temperature for heating the transparent conductive film and a temperature of the transparent conductive film stored in the characteristic storage step is obtained, a resistance value variation amount is obtained by multiplying the obtained difference by a resistance temperature coefficient stored in the characteristic storage step, and a target resistance value for the transparent conductive film is obtained by adding the resistance value of the transparent conductive film stored in the characteristic storage step to the obtained resistance value variation amount.
